(19) United States
(12) Patent Application Publication
(10) Pub. No.: US 2008/0316524 A1
(43) Pub. Date: Dec. 25, 2008

(54) Method and System for Automatically Selecting a Device for Document Processing Order Treatment

(76) Inventors: Didier Lefebvre, Limal (BE); Jean-Marc Bodart, Louvain-la-Neuve (BE)

Correspondence Address: SCHIFF HARDIN, LLP;PATENT DEPARTMENT, 6600 SEARS TOWER, CHICAGO, IL, 60606-6473, US

(21) Appl. No.: 11/574,468

(22) PCT Filed: Sep. 28, 2005
(86) PCT No.: PCT/EP05/10499

§ 371 Date: Feb. 28, 2007

(30) Foreign Application Priority Data
Sep. 29, 2004 (DE) 10 2004 047 326.9

(51) Int. Cl. G06F 3/12

(52) U.S. Cl. 358/1.15

(57) ABSTRACT

For automatic selection of an apparatus for processing of a document processing job, features of the document processing job are compared with features necessary for execution of the document processing job of each apparatus available. In the even that it results from the comparison that a plurality of apparatuses possess the necessary features, a most suitable apparatus among the plurality of suitable apparatuses is selected via a further comparison of the features of the document processing job with features of the apparatus that are necessary for execution of the document processing job.

### BACKGROUND

The preferred embodiment concerns a method and a system for automatic selection of an apparatus for processing of a document processing job.

An order distribution system (ODS) that is also designated as a workflow manager is described in “Das Druckerbuch, Technik und Technologien der OPS Hochleistungsdrucker”, Edition 5a, October 2000 (ISBN 3-00-001019-X). The entire digital printing process, which comprises a printing pre-stage, a high-capacity printer and a final processing, can be controlled with this order distribution system. Image and text files from different sources (such as scanners, digital camera, data medium or a computer network) are consolidated in the printing pre-stage and are brought into their ultimate form at a layout station. A printer driver subsequently converts the data created at various platforms into, for example, PostScript files. These files can then be passed to a print server for printing. Print servers convert the data into compressed bitmaps that are imposed in a fully automatic manner and are relayed to the printing system. The print server controls the printing process. The final processing of the print product comprises, for example, the binding or insertion of divider sheets.

The order distribution system is moreover responsible for central administration of the production variants. The print service for intranet and internet users also belongs to this. The order distribution system informs users about approved production variants, undertakes print jobs together with digital job cases, initiates the automatic execution up to the printing. The order distribution system also monitors the correct execution of the selected printing and post-processing options.

The order distribution system here executes what are known as job tickets. A job ticket is a file that is created by the user upon creation of the print job, in which print job are contained all specifications that are to be executed in the printing process. Conventional job tickets comprise unambiguous instructions that are to be correspondingly implemented.

The printing process is increasingly more comprehensive since ever more apparatuses are integrated into a printing process, whereby the functionality increases. Due to the internet and intranet, printing processes are additionally increasingly executed distributed regionally or are associated with a pool of printers that can be regionally distributed. Moreover, apparatuses of different manufacturers must increasingly cooperate in a process. In order to cope with these increased requirements, a unified specification for exchange of data formats in the printing process was agreed upon, which specification is designated as a job definition format (JDF). For this there is a corresponding job messaging format (job messaging formats or JMF) that is correspondingly specified. The specification of JDF can be downloaded from the Internet site www.cip4.org; the current specification at the moment is JDF Specification Release 1.2.

JDF is an XML-based format in which the instructions for the printing process are arranged in a tree structure. Each node (node) of the tree structure comprises an instruction or a set of instructions. The uppermost node is designated as a root. The end nodes at branches are designated as leaf nodes (leaf nodes).

The specialty of JDF lies in that there can be what are known as intent nodes that contain a very general instruction for a printing process that must be rendered more precisely in order to be able to be executed on an apparatus. This more precise rendering, which is also designated as a resolution (resolution), is executed by a corresponding controller in the course of the printing process in that one or more further nodes that render the instruction of the intent node more precisely are subordinate to the intent node. This resolution can occur in steps, meaning that a cascade of further nodes are subordinated to an intent node in steps, whereby the exact instructions for the apparatus (in particular the printer) are contained in the last node (the leaf node).

The resolution of the intent instructions into precise instructions up to the commands contained in the leaf nodes occurs by means of programs that are designed similar to device drivers and that convert general intent instructions into more concrete intent instructions or into concrete commands for a printer or an apparatus. Specifications about resources that are contained in the respective nodes are also taken into account in this conversion. According to the JDF specification, all resources are all things that are consumed or produced. They comprise physical objects (such as, for example, paper, ink) or data in the form of files or parameters. A resource has an XML ID with which it is identified in the overall job ticket.

Given such methods in which document processing jobs are automatically processed by means of a system that comprises a plurality of networked computers, the apparatuses that execute the document processing job (such as printer, folding device, hole punching device and the like) are often also automatically determined. This occurs in that specific criteria are predetermined by the print job and an apparatus is selected that corresponds to these criteria. This method has proven itself very well for conventional systems for automatic processing of document processing jobs. However, if document processing jobs according to the JDF format are used that are initially very nonspecific and are rendered more precisely in the course of the processing, it has arisen that the selection of the apparatuses is often not optimal.

A method for selection of one printer from a plurality of printers from a group of printers on the basis of the attribute of the printer by means of a corresponding printer driver is known from DE 101 48 680 A1. Attribute requirements are thereby extracted from the print job and applied as selection criteria for the printers, in that printers whose attributes do not satisfy the selection criteria are faded out in a list provided to the user for selection of a printer. Effectively, multiple printers whose attributes correspond to all attribute requirements and from which the user must for his part again determine or select a printer are thus normally offered to the user in a one-step automatic method.

A printer server that is connected with a plurality of printers arises from U.S. Pat. No. 6,476,927 B1. When the print server receives a print job that is provided with a job ticket, the print server determines whether apparatuses are compatible with the print job. The print server checks whether at least one printer satisfies the requirements. The print server selects one of the printers using predetermined criteria (print time, costs, location).

A printer selection system is described in US 2002/075509 A1. Given this selection method the next closest printer is initially determined for a specific print job. It is afterwards checked whether the next closest printer corresponds to predetermined requirements. In the event that this is not the case, this printer is deleted as a potential candidate. These requirements comprise, for example, the possible print color, paper size, resolution, print time and the costs to be expected. The next closest suitable printer can always be determined with this method.

A centralized printing system that allows what is known as an intent-based printing (meaning that the end consumer or user can specify the end result of the printing process without having to select the print resources for this) arises from U.S. Pat. No. 6,621,589 B1. A print job manager processes the print job using the attributes selected by the user, whereby the print job manager independently selects the print resources from a group of print resources. The print job manager uses an algorithm in order to determine how the individual job processing attributes are to be implemented. In principle, hardware-supported attributes accordingly have a greater weighting than software modules that provide the same function. A printer that can repeatedly output a print product by means of hardware is thus preferably used instead of a software solution that executes a repeated printout of this document at a printer. A processing attribute that possibly cannot be executed automatically but rather can be executed only manually by a user possesses a low weighting. For example, a printing process can be executed on a fast printer even if it cannot staple. Furthermore, individual attributes can be associated with priorities.

A printer driver that can simultaneously address a plurality of printers is disclosed in US 2003/231328 A1. The status of the individual printers can be monitored with this printer driver. The printers can thus be queried at predetermined points in time. This status query can check whether a printer is executing a print job at the moment, whether the printer is connected with the network or (in the event that this is possible at the printer) resistance of individual consumable materials (paper) is present.

### SUMMARY

It is an object to achieve a method and a system for automatic selection of an apparatus for processing of a document processing job, the processing also delivering an optimized apparatus selection given use of document processing jobs present in the JDF format.

For automatic selection of an apparatus for processing of a document processing job, features of the document processing job are compared with features necessary for execution of the document processing job of each apparatus available. In the even that it results from the comparison that a plurality of apparatuses possess the necessary features, a most suitable apparatus among the plurality of suitable apparatuses is selected via a further comparison of the features of the document processing job with features of the apparatus that are necessary for execution of the document processing job.

### BRIEF DESCRIPTION OF THE DRAWINGS

FIG. 1 shows a system for execution of the method of the preferred embodiment in a block diagram.

FIG. 2 illustrates the method for resolving intent instructions in a job ticket by means of a template; and

FIG. 3 illustrates the workflow of the method for selection of a suitable apparatus, in particular of a printer for a printing process.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

The method of the preferred embodiment for automatic selection of an apparatus for processing of a document processing job comprises the following steps:
comparison of features of the document processing job with features (which features are necessary for execution of the document processing job) of each apparatus available for execution of the document processing job, which features are designated as capabilities,
in the event that it results from this comparison that a plurality of apparatuses possess the necessary capabilities, the most suitable apparatus under the plurality of suitable apparatuses is selected via a further comparison of features of the document processing job with features of the apparatus that are not necessary for execution of the document processing job (which unnecessary features are designated as affinities).

Via the two-stage selection of the apparatuses according to capabilities and affinities, not only are apparatuses sought out that are suitable in principle for processing of the document processing job, but rather a preferred apparatus is selected according to the criteria of the affinities in the event that a plurality of suitable apparatuses should be present. An optimized selection of apparatuses is hereby achieved that can occur without further techniques and in particular automatically. This is particularly advantageous in connection with document processing jobs according to the JDF specification since, given the creation of such document processing jobs, the apparatuses are normally not yet selected and there is often a plurality of suitable apparatuses (in particular in what are known as production printing environments), whereby the most suitable apparatuses are conventionally normally not selected. With the method of the preferred embodiment the document processing job is optimized with regard to costs, quality and processing time via selection of the most suitable apparatus.

The method and system of the preferred embodiment is [sic] based on the application of the JDF format as it was explained in the preceding. The JDF format as it is known from JDF Specification Release 1.2 is, [sic] as well as the XML code, hereby used and assumed to be known in the subsequent explanation of the preferred embodiment and are not described again. The JDF Specification Release 1.2 is incorporated entirely in terms of content.

A system 1 for execution of the method of the preferred embodiment comprises a network 2 with data lines for exchange of data. This network can be as an internet, an intranet, or a local network (LAN) or a supra-regional network (WAN). It can naturally also be a combination of different network types. One or more clients 3, one or more servers, or controllers 4 are connected over this network 2. Apparatuses 5 for execution of specific tasks of the printing process are connected to the servers or controllers 4. These apparatuses 5 are primarily printers 5/1 through 5/6 and apparatuses 5/7, 5/8 for post-processing of the printed media 6 such as, for example, an apparatus 5/7 for punching of holes or an apparatus 5/8 for binding of the printed sheets.

The medium 6 to be printed is normally paper. However, it can also comprise another material such as, for example, films.

The system and the method of the preferred embodiment are primarily provided for printing processes executed with digital electrophotographic high-capacity printers. Such methods are on the one hand significantly more flexible in comparison to the offset printing method, such that they are also suitable for small quantities; on the other hand, in the meanwhile they have also become capable such that they are also suitable for the execution of more elaborate printing processes such as, for example, for generation of books in small editions and the like.

The clients 3 are computers connected at the network 2, on which computers application programs are stored and executed, with which application programs files to be printed are generated. These application programs can be text processing programs, professional layout programs with which texts and graphics are combined and stored in a file to be printed. Given the use of the JDF format the job ticket and a further file that contains the data to be printed are normally generated. The data of these two files can also be stored in a single file. The result of the printing process is initially defined with the job ticket according to the JDF format. In the further processings of the print job the job ticket is rendered more precisely such that it describes the workflow of the printing process, which is also designated as a workflow. Given use of the JDF format, the result of the printing process is defined at the client 3 in the job ticket with intent instructions. Such intent instructions comprise, for example, only the specification that a book or a newspaper should be printed. The job ticket can naturally also comprise more advanced specifications in the event that they have been established by the user at the client 3.

The job ticket and the data to be printed are relayed to a first server 4/1 via the data network 2. This server distributes the print jobs to specific print centers 7 that respectively comprise one or more printers 5 and a corresponding controller or server 4. A server for printing processes (which is also designated as a print server) is a computer that is suitable to relay print jobs to one or more printers. To the contrary, by controller what one understands is a digital control device that is associated with a specific apparatus 5 or a specific printer 5. Both a print server and a controller are equipped for processing of data with a CPU and data storage and can resolve the JDF job ticket. In the following they are therefore designated exclusively as a server 4.

In a first server 4/1 that distributes the print jobs between two print centers 7/1 and 7/2, the job ticket can be resolved in a first stage in that, for example, specific process steps are defined. For example, if a print comprises only black-and-white printers, the first server 4/1 can further resolve the job ticket to the effect that the print job is to be executed in black-and-white.

The print center 7/1 comprises a server 4/2 and three printers 5/1 through 5/3.

In contrast to this, the print center 7/2 comprises two servers 4/3 and 4/4, whereby the server 4/3 is for controlling three printers 5/4, 5/5 and 5/6, and the server 4/4 is for controlling two post-processing apparatuses 5/7 and 5/8 for punching or for binding of the printed products.

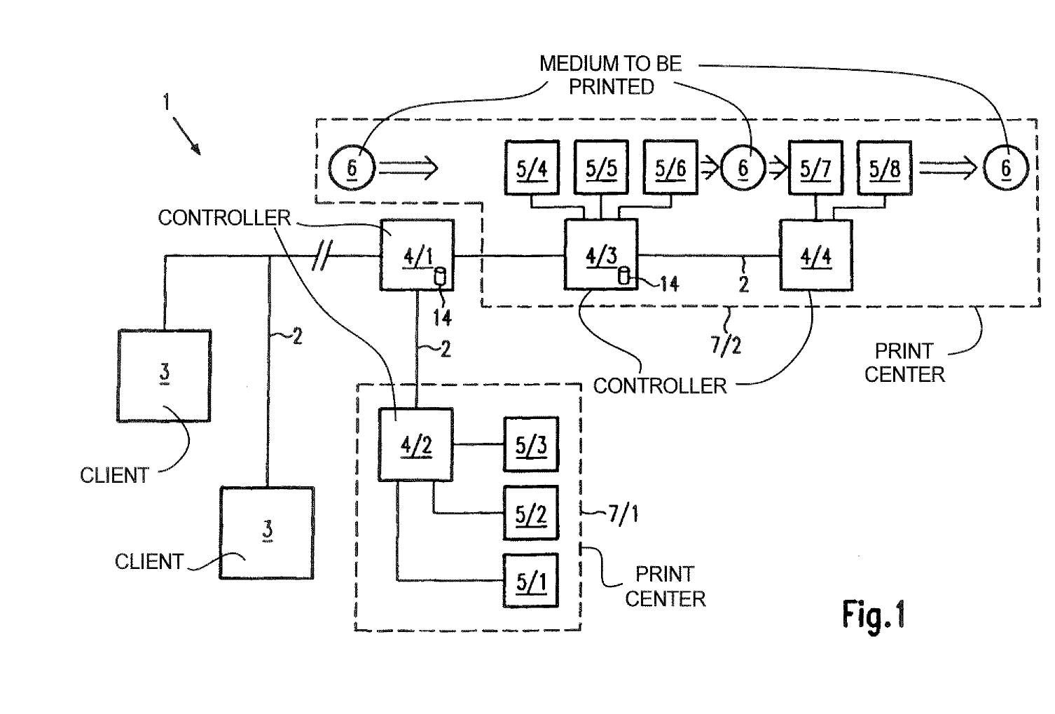

The printing process comprises all steps as they are shown in FIG. 1 in the print center 7/2, beginning with the printing of a medium 6 at one of the printers 5/4 through 5/6 and a post-processing at least one of the post-processing apparatuses 5/7 or 5/8.

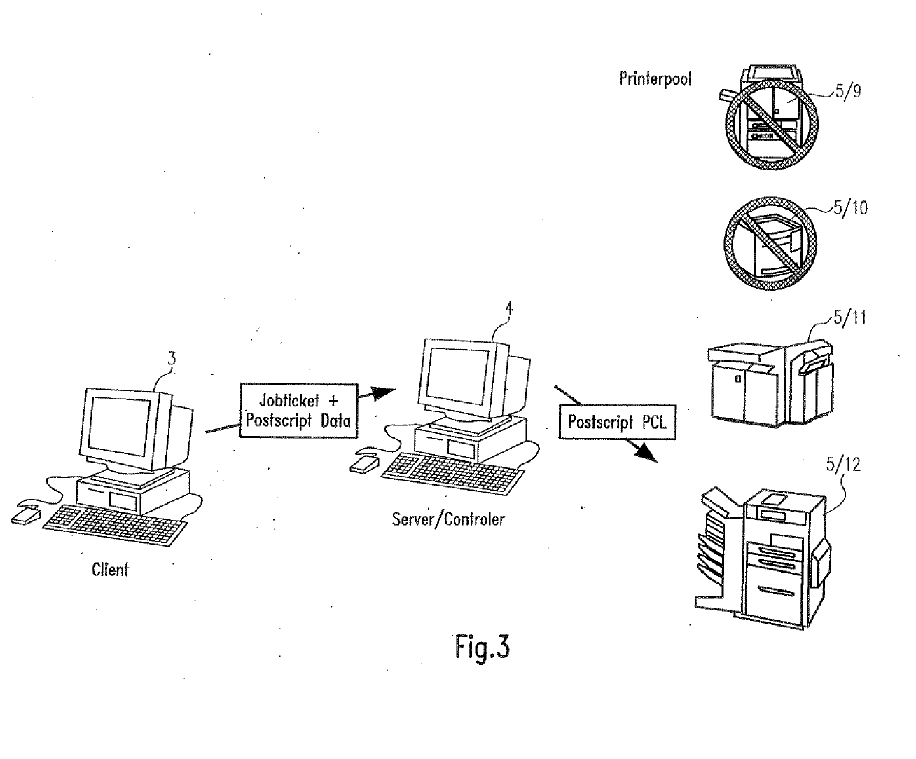

The association of a specific print job with an apparatus (in particular a printer) is subsequently explained by way of example using the scheme shown in FIG. 3.

A print job is generated at a client 3 and normally comprises (as is explained above using FIG. 1) a job ticket and a further file that comprises the data to be printed. The job ticket corresponds to the JDF format.

The print jobs are respectively associated with one of a plurality of apparatuses at the server 4. A printer pool with four printers 5/9 through 5/12 is schematically shown in FIG. 3.

In the preferred embodiment the document processing jobs or print jobs are distributed by the server 4 according to two criteria: the capabilities (capabilities) and the affinities (affinities).

The criterion of the capabilities corresponds to the JDF format. Features of the print job are here compared with capabilities of the individual apparatuses that are necessary for execution of the document processing job. These capabilities are stored on the server in the form of lists associated with the respective apparatuses. Typical capabilities that are taken into account in this comparison are:

### Auto-Routing Enabled

The capability “auto-routing” must be active at the printer; otherwise the printer cannot accept a print job automatically relayed from the server.

### Color

The printer is normally designed either for single-color printing (monochrome) or multi-colored printing (CMYK).

### Duplexing

The printer can be set for one or more duplex modes. For example, one-sided printing and two-sided printing fall under this. There are a series of modifications of this in which the edges, the arrangement of the print image on the paper, and the like can be processed differently.

### Side Switching Enabled

The print order is changed with side switching such that the back side is printed first. This is appropriate given some applications such as, for example, duplex printing.

### Allowed User

At the apparatus the capability must be set that a user can use this apparatus so that a print job from this user can be processed at this apparatus.

### Page Threshold

At some apparatuses a page threshold is predetermined that establishes the range of the pages to be printed of a single print job. In the comparison of the capabilities the number of the pages of the document to be printed is multiplied at the print server 4 with the number of the copies of the document to be printed and the product resulting from this must lie inside the predetermined range.

### Media

The print medium requested with the print job must be supported by the apparatus and be present at or capable of being supplied to this apparatus.

### Advanced Paper Handling (APH) Enabled

In the event that, for example, a change of the print medium or a printing of a binding is required in the print job, it is then necessary that the capability “advanced paper handling (APH)” is active.

### Mailbox

Given some print jobs it is necessary that a mailbox is activated so that, for example, the print job at the printer can only be resolved via input of a specific password.

In the event that it is established at the server 4 that none of the apparatuses fulfills the capabilities required by the print job, the print job must be rejected by the server 4 as non-executable.

In the event that a single apparatus satisfies all capabilities required by the print job, the print job is assigned to this apparatus by the server 4. The corresponding files are hereby converted at the server 4 into a bitmap file and transferred to the printer that then executes the printing process corresponding to the bitmap file, or the print job is transferred in the form of the job ticket and the corresponding data file to the printer at which the bitmap file is generated from these data by means of a controller for control of the printing process. If the job ticket is transferred from the server 4 to the printer 5, it is further resolved on the server 4 in that a node for execution of the print job is entered into the job ticket on this server.

However, in the event of a plurality of apparatuses that satisfy the necessary capabilities, the criterion of the affinities is taken into account with the present invention. Affinities are corresponding features of the document processing jobs and of the apparatuses that do not necessarily have to be fulfilled for execution of the job.

In the example schematically shown in FIG. 3, the printers 5/9 and 5/10 do not fulfill the required capabilities. The printers 5/11 and 5/12 are available for the further selection.

The selection of the affinities differs in principle from the selection according to capabilities. Given the selection according to the criterion of the capabilities, a strong correlation must exist between the required capabilities and the capabilities of a selected printer. Contrarily, given the selection according to the affinities it is attempted to discover the most suitable printer or the most suitable apparatus from a set of suitable apparatuses. Affinities desired by the print job are hereby compared with affinities offered by the respective printers.

The selection can, for example, occur in that the apparatus that satisfies the most desired affinities is selected. However, the individual affinities can also be weighted with a weighting factor that is greater the more important that the respective affinity is for the selection of the apparatus. The apparatus is hereby selected that exhibits the affinities required by the print job with the greatest weighting factor in total.

The comparison of the affinities can also occur in that the affinities are checked in a specific order, whereby all suitable apparatuses are taken into account given a check of a respective affinity. If an advantage for one apparatus relative to all other suitable apparatuses arises given an affinity, this apparatus is selected and the check of the further affinities is no longer executed. Given this method the order of the affinities is important. The most important affinities are checked first and the less important affinities are checked at the end.

Some examples for affinities are listed in the following:

### APH Inserts/Unprinted Covers

The number of the divider sheets and unprinted covers that the apparatus can generate is calculated. The apparatus with the greatest number is preferred as necessary.

### Finishing

There are a plurality of processing steps that the apparatus can execute. The apparatus that can execute the greatest number of the processing steps desired by the print job is preferred. Examples for such processing steps are:
stacking of the printed sheets: there are a plurality of variants of how the printed sheets can be stacked.
binding: there are a plurality of variants of how a printout can be bound (thread binding, glue binding)
collating: it is checked whether the apparatus allows collating.
punching: here it is checked whether the apparatus can punch holes.
folding: here it is checked whether the apparatus can effect a desired folding.

### Preferred Device

A specific apparatus can be specified as a preferred apparatus in a print job. This is checked with this affinity. If a weighting of affinities exists, this affinity is to be weighted very high since it corresponds to the explicit desire of the generator of the print job.

With the affinity of the apparatus availability it is checked whether the apparatus is located in an “idle cycle” (idle) or whether it is “in operation” (running). An apparatus located in an idle cycle is preferred.

### Speed

The apparatus with the highest processing speed is preferred.

### Least Recently Used

The apparatus that has not been used for the longest time is preferred.

Given the presence of a plurality of equivalent apparatuses, a uniform distribution of the print jobs to the apparatuses is hereby effected.

If a specific apparatus is selected, a further node in the job ticket is generated that is a leaf node; this means that it can be directly executed at the apparatus.

There is no specific association to the effect that a specific feature is to be checked as a capability or as an affinity. Rather, it is also possible to also consider in the check of the affinities specific features that were considered in the check of the capabilities. According to the JDF format, features that are considered in the check of the capabilities must be compared with the resources specified in the job ticket. To the contrary, the affinities are features of each arbitrary property of the job ticket and do not have to be limited to features of the resources.

The selection of an apparatus according to affinities as it is described above allows the determination of the most suitable apparatus in a complex printing process, whereby the determination must only occur at a print server that can be directly upstream of the printers in the process chain.

Given conventional methods the apparatus is selected either by the generator of the print job or manually by an operator of a print server.

With the preferred embodiment the selection of the most suitable apparatus occurs on the one hand automatically and on the other hand significantly faster, whereby a plurality of selection parameters (meaning a plurality of affinities) can also be considered. This represents a significant increase of the quality of the workflow of the printing process.

This in particular applies in connection with print jobs according to the JDF format, in which intent instructions are contained in the job ticket. Since these intent instructions are very non-specific, it can also initially be left completely open which apparatus is most suitable for execution of the print job. The necessary capabilities are only defined in detail in the course of the resolution. However, a selection solely according to the capabilities is not always optimal with regard to costs, speeds, economy and quality of the print product. With the additional selection according to affinities, the print process can automatically be optimized with regard to costs, speed, economy and quality of the printing process so that with such a JDF printing process it is possible to keep the print job optimally non-specific at the beginning of the generation of the same and nevertheless to execute with an optimized apparatus selection that is initially not established.

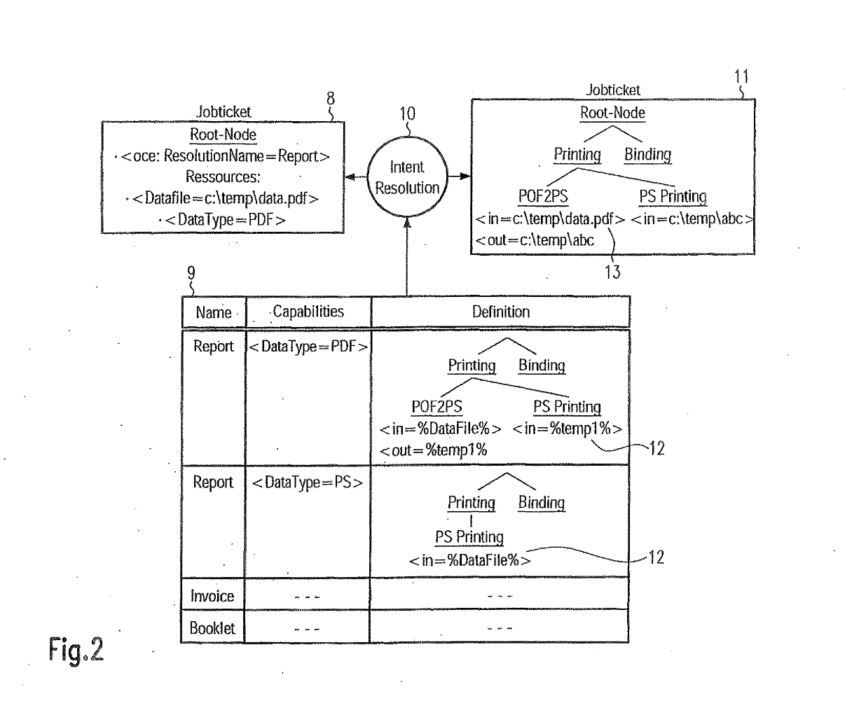

The resolution of a job ticket is subsequently exemplarily explained with an intent instruction using the scheme shown in FIG. 2.

A job ticket 8 that comprises a root node (root node) is schematically shown in FIG. 2. In this root node it is defined that the data to be printed should be printed as a “report” and it is specified in which file (c:\temp\data.pdf) the data are located and which manner of file type (PDF) this file is. Only the significant excerpts of the definition of such a root node are shown in FIG. 2. For simplification of the representation, the XML format is hereby not followed.

The term “Report” represents a name of a template. How in such a report it is printed is not defined in the job ticket 8.

If the job ticket 8 reaches one of the servers in which a resolution table 9 is located (which resolution table comprises a series of templates), and if a suitable template is provided this template is read out and subordinated to the root node. This step is designated as an intent resolution 10.

The selection of the template occurs on the one hand dependent on the name of the template (which, in the present exemplary embodiment, reads “Report”) specified in the intent instruction. A further criterion for selection of the template are the resources that are specified in the job ticket 8. For example, the table 9 comprises two templates with the designation “Report” that differ in terms of their capabilities (capabilities). The capabilities are a characteristic of the template that correspond to the resources of the job ticket. The resolution table 9 comprises a template “Report” with the capability to process PDF files and a further template with the designation “Report” with the capability to process PostScript files. The job ticket 8 comprises as a resource the data type PDF, which is why the template “Report” for the data type PDF is selected from the table 9. The definition of this template is read out and inserted into the job ticket, whereby the definition of the template is subordinated to the root node of the tree structure. A further-resolved job ticket 11 thus results.

Given insertion of the definition of a template into a job ticket, variables 12 in the template are replaced by corresponding values 13. These values can on the one hand be extracted from the resources specified in the job ticket 8; on the other hand, they can be contained in a list generated for a specific job ticket or be replaced by predetermined specification values (default values) that are stored independent of the job ticket at the server 4 that executes the resolution. At least one part of the instructions of the template is hereby made executable.

With this exemplary embodiment two nodes Printing or Binding are directly subordinated to the root node. Two further nodes, namely PDF2PS and PS printing, are subordinated to the node Printing. The node PDF2PS means that a PDF file is converted into a PostScript (PS) file. The corresponding input and output files are specified. In the job ticket 1i the nodes PDF2PS and PS printing represent leaf nodes of the tree structure since they can be executed directly at a server (PDF2PS) or at a controller of a printer (PS printing).

The insertion of a single template into a job ticket is shown using this example. Not merely one template but rather a plurality of templates is typically inserted into a job ticket. This means that a general intent instruction is increasingly rendered more concretely via the addition of further nodes. As is also the case in the present example, a template can itself comprise a plurality of nodes. The resolution of the intent instructions in concrete commands for control of a printer can also occur in steps distributed over a plurality of servers.

For the preferred embodiment resolution of intent instructions occurs via insertion of templates that are selected based on their name and their capabilities. All sub-processes of a printing process can be comprised with this scheme since the individual sub-processes are respectively provided for completion of a specific task and depend on the available resources. These resources can thus be files and properties of files, but also objects or properties of objects such as, for example, paper or the format of paper.

If the resource changes, a different template is to be selected. For example, if the job ticket 8 in FIG. 2 were to contain PS for the PostScript format as a file type, the further template with the designation “Report” in which the data are printed directly would have to be selected since they already exist in the PostScript format and no longer have to be converted from a PDF format into a PostScript format.

This schematic of the template can be reconstructed very simply without particular software knowledge. Insofar as he possesses basis knowledge of the XML format, a user can thus define his own template. High-capacity printing systems are typically attended by personnel who possess such basic knowledge. An editor for editing of the template is therefore advantageously provided.

A preferred method for updating of the lists of the features (for example capabilities, affinities) of an apparatus that are stored in a server is subsequently explained.

According to the JDF format, the current features of the apparatus are transmitted upon a specific query by a server to an apparatus, whereby a complete list of all features is always transferred.

In the method of the preferred embodiment a server can alter the query to the effect that only changes of the features of the apparatus (delta messages) are transferred. Upon such a query the complete list of the features is initially transferred once from the apparatus to the server and only the changed features of the descriptive data are subsequently transferred given changes.

A mixed transfer of the data can also be requested, whereby every Nth message comprises the complete list of the features and all further messages merely comprise the changed features of the apparatus. This mixed transfer is preferred when the server should be synchronized with the connected apparatuses at regular intervals. For the automatic selection of an apparatus according to the criteria of the capabilities or the affinities it is necessary that the corresponding lists of the features of the apparatuses are current. The data volume to be transferred can be limited with the method of the transfer of messages that merely comprise data of the changed features (delta messages). That is very advantageous given a large branched printing system in which a more intensive exchange of data exists in principle.

A preferred embodiment of the server 4 (FIG. 1) is subsequently explained according to which a storage space 14 associated with a client is set up on one of the servers 4. This storage space is subsequently designated as a client storage space 14.

The print servers 4 exhibit powerful functions for processing of documents to be printed. They can thus sometimes convert from arbitrary print data streams (for example AFT, PCL, PPDS, AFPDS, IPDS) into graphical files of other formats such as, for example, the PDF format. These conversion functions are provided in order to convert the data received with the print data stream into a format suitable for the respective printer. Some of these print formats are very printer-specific. However, there are also formats that are used not only for printing at the printer but rather also can be used otherwise. At the client 3 an interface is provided to the user, with which interface the user can access the client storage space 14 at one of the servers 4 and therewith can access the print data in the converted formats.

A program packet is associated with the client storage space 14 at the respective server 4, in which program packet the following functions can be executed:

### View

The document stored in the client storage space 14 can be viewed with the function “view”. With this function the print job can be monitored before it is printed out. In connection with the use of the JDF format this is very advantageous since how the original, not very precisely defined JDF job ticket has been resolved and the print data have been accordingly converted can be monitored with this.

### E-Mail

The document can be sent with the function “e-mail”.

### Send to Archiving

The function “send to archiving” allows the document to be transmitted to an archiving system.

### Follow-Me

The function “follow-me” allows a print job to be stored in the client storage space 14, whereby the print job has been output to one of the clients 3. The user can then retrieve this print job from a further client, a server or even the printer (insofar as this comprises corresponding input means) itself at any later point in time and be printed out at a printer selected by the user. The selection of the printer hereby occurs only with the retrieval of the print job from the client storage space 14. For the user this function offers the advantage that he does not have to establish the location at which the print file is printed out upon generation of the print job, but rather can have the print job retrieved and printed out there on site at a later point in time when he is, for example, located at a different location.

In this embodiment the interface provided at the client 3 for communication with the server serves for quitting of print jobs, monitoring of the print jobs and for organization of the client storage space 14.

A method for automatic transmission of print jobs from a client to a server is subsequently explained.

In this method local data directories (folders) at the client or an arbitrary location on the network are configured as file folders to be monitored (hot folders). One of the servers 4 can directly access these file folders to be monitored. The server 4 is configured such that it regularly monitors these file folders to be monitored as to whether they comprise a complete print job. A print job comprises a file that exists in a format to be printed (PostScript, PCL, TIFF or PDF) and comprises a JDF job ticket. If such a complete print job is stored in a file folder to be monitored, one of the servers 4 reads out this print job and directs it to the further processing.

Given a modification of this monitoring function, a complete print job of a directly to be monitored does not necessarily have to exist, rather only a file in a printable format. This file is then read by one of the servers 4 and processed further together with a specification JDF job ticket (default job ticket).

The preferred embodiment can be briefly summarized as follows:

The preferred embodiment concerns a method and system for automatic selection of an apparatus for processing of a document processing job.

The preferred embodiment is characterized in that two criteria can be considered in the selection of an apparatus, namely the selection according to capabilities (which are corresponding features of the document processing job and of the respective apparatus that must necessarily be satisfied for execution of the job) and, on the other hand, according to affinities (which are corresponding features of the document processing job that do not necessarily have to be fulfilled, however are advantageous for the execution of the document processing job).

This method is in particular advantageous for document processing jobs according to the JDF specification since such document processing jobs are initially generated very non-specifically and the selection of the apparatus normally arises in the further automatic processing of the document processing job. An optimization of the processing of the document processing job with regard to costs, speed, economy and quality of the process is achieved via the preferred embodiment.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-21. (canceled)

22. A method for automatic selection of an apparatus for processing of a document processing job, comprising the steps of:
comparing features of the document processing job with features necessary for execution of the document processing job of each apparatus available for execution of the document processing job, said features being designated as necessary capabilities; and
in the event that it results from said comparison that a plurality of apparatuses possess the necessary capabilities, a most suitable apparatus among the plurality of suitable apparatuses is selected via a further comparison of the features of the document processing job with features of the apparatus that are not necessary for execution of the document processing job, said unnecessary features being designated as affinities.

23. A method according to claim 22 wherein the affinities are checked in a specific order, whereby given a check of a respective affinity all suitable apparatuses are considered, and if an advantage for one apparatus relative to all other suitable apparatuses results in a check for a specific affinity this apparatus is selected and a check of the further affinities is terminated.

24. A method according to claim 22 wherein the apparatus that satisfies the most affinities desired by the document processing job is selected in the check for affinities.

25. A method according to claim 22 wherein the affinities are weighted corresponding to their importance, and the apparatus is selected that exhibits the affinities required by the print job with the greatest weighting factor in total.

26. A method according to claim 22 wherein lists of the features of apparatuses that are connected with the server are stored at a server executing the method, whereby the lists are regularly updated in that only changes of the respective apparatus are transferred.

27. A method according to claim 26 wherein complete lists of the features are transferred from the respective apparatus to the server at regular intervals, and in between said intervals only changes of the features of the respective apparatus are transferred from the apparatus to the server.

28. A method according to claim 22 wherein local file folders are configured at a client or an arbitrary location on the network as file folders to be monitored and one of the servers monitors said file folders as to whether a document processing job is present, and when this is the case reads out this document processing job and automatically passes it to the further processing.

29. A method according to claim 28 wherein a document processing job is only read out when it comprises both a file containing the data to be printed and a corresponding job ticket.

30. A method according to claim 28 wherein each file is read out in a printable format and is supplied with an advance job ticket to the further processing.

31. A method according to claim 22 wherein a document processing job is processed that corresponds to a JDF format.

32. A method according to claim 22 comprising the further steps of:
Imparting a job ticket with a tree structure in which is contained at least one intent node in which is listed at least one template name and one resource;
determining the template name specified in the intent node and the resources listed in the intent node;
selecting a template that exhibits the template name and possesses the capabilities to handle or process the resources specified in the intent node; and
inserting the selected template into the tree structure of the job ticket whereby it is subordinate to the respective intent node.

33. A method according to claim 32 wherein the template comprises one or more variables that are automatically replaced by a value upon insertion of the template into the job ticket.

34. A method according to claim 33 wherein the value is extracted from one of the resources specified in the job ticket.

35. A method according to claim 33 wherein the value is extracted from a predetermined list of values that was generated in advance for said job ticket, or a predetermined default value that is stored independent of the job ticket is used as the value.

36. A method according to claim 32 wherein document processing jobs are distributed to apparatuses by a server dependent on two criteria, namely the capabilities and the affinities at which apparatuses the document processing jobs are executed.

37. A system for selection of an apparatus for processing of a document processing job, comprising:
a network via which at least one client, one server or controller, or one apparatus for execution of a printing process are connected; and
the server or controller being designed to perform the steps of
comparing features of the document processing job with features necessary for execution of the document processing job of each apparatus available for execution of the document processing job, said features being designated as necessary capabilities, and
in the event that it results from said comparison that a plurality of apparatuses possess the necessary capabilities, a most suitable apparatus among the plurality of suitable apparatuses is selected via a further comparison of the features of the document processing job with features of the apparatus that are not necessary for execution of the document processing job, said unnecessary features being designated as affinities.

38. A system according to claim 37 wherein the apparatuses comprise at least one electrophotographic printer.

39. A system according to claim 37 wherein a client storage space is set up on the server or controller, said client storage space serving for storage of print documents converted into a print format and which are accessible by a client by an interface.

40. A system according to claim 39 in which a function comprising at least view a document, send document via e-mail, transmit document to an archiving system, or buffering a document for a later printout are associated with client storage space.

41. A system according to claim 40 wherein the function for buffering of a document processing job is designed such that the document processing job is retrievable from any point on the network, and the printer at which it is to be printed out is selectable.

42. A system for selection of an apparatus for processing of a document processing job, comprising:
a network via which at least one client, one server or controller, or one apparatus for execution of a printing process are connected; and
the server or controller being designed to perform the steps of
comparing features of the document processing job with features necessary for execution of the document processing job of each apparatus available for execution of the document processing job; and
in the event that it results from said comparison that a plurality of apparatuses possess the necessary features, a most suitable apparatus among the plurality of suitable apparatuses is selected via a further comparison of the features of the document processing job with features of the apparatus that are not necessary for execution of the document processing job.

43. A method for automatic selection of an apparatus for processing of a document processing job, comprising the steps of:
comparing features of the document processing job with features necessary for execution of the document processing job of each apparatus available for execution of the document processing job; and
in the event that it results from said comparison that a plurality of apparatuses possess the necessary features, a most suitable apparatus among the plurality of suitable apparatuses is selected via a further comparison of the features of the document processing job with features of the apparatus that are not necessary for execution of the document processing job.
